(19) United States
(12) Patent Application Publication
(10) Pub. No.: US 2012/0237036 A1
(43) Pub. Date: Sep. 20, 2012

(54) COMMUNICATING SCRAMBLING SEED INFORMATION

(75) Inventors: ANAND DABAK, PLANO, TX (US); JEAN PICARD, HOOKSETT, NH (US)

(73) Assignee: TEXAS INSTRUMENTS INCORPORATED, Dallas, TX (US)

(21) Appl. No.: 13/405,431

(22) Filed: Feb. 27, 2012

Related U.S. Application Data
(60) Provisional application No. 61/453,009, filed on Mar. 15, 2011.

(51) Int. Cl. H04K 1/04

(52) U.S. Cl. 380/287

(57) ABSTRACT

A method of communicating scrambling seed information includes obtaining raw data to be transmitted using a processor, and generating scrambled data from the raw data according to a scrambling seed. A scrambled data packet structure is configured by combining a preamble portion, a synch portion, and a header portion to the scrambled data, wherein the header portion includes a scrambler field value including a plurality of bits (M). The scrambled data packet structure is transmitted to a receiver. The receiver receives the header portion including the scrambler field value. The receiver maps the scrambler field value to a scrambling seed, and decodes the scrambled data using the scrambling seed.

### CROSS REFERENCE TO RELATED APPLICATIONS

This application and the subject matter disclosed herein claims the benefit of Provisional Application Ser. No. 61/453,009 filed Mar. 15, 2011, which is herein incorporated by reference in its entirety.

### FIELD

Disclosed embodiments relate generally to the field of communications that utilize data scrambling.

### BACKGROUND

Many computer system or electronic interfaces integrate various types of functions, including data and electrical power delivery. For example, an interface can provide a port for signaling and power delivery between computer devices and associated external peripherals.

Existing solutions for Universal Serial Bus (USB) 2.0 and USB 3.0 provide power delivery to and from USB devices and hosts. Details regarding the Universal Serial Bus (USB) are described at the USB Specification Revision 2.0 published Apr. 27, 2000 entitled “Universal Serial Bus Specification”; and the USB 3.0 Specification Revision 0.85 published Apr. 4, 2008 entitled “Universal Serial Bus 3.0 Specification”; the contents of each are incorporated herein by reference in their entirety. For example, the USB 3.0 specification defines a maximum power delivery of 4.5 W (USB 3.0 maximally supports six (6) 150 mA loads at 5V).

In USB power delivery communications and other communications, including wireless communications, a scrambler may be used to reduce the probability of having long strings of zeroes or ones appear in transmitted data by whitening the transmitted data (i.e., to make the transmitted data appear more random), to reduce the DC offset in the data pattern. The scrambler may generate a scrambling code pattern based on what is termed in the art a “scrambling seed” to generate scrambled data. The receiver includes a descrambling device which when provided the specific scrambling seed used by the transmitter allows the seed within the scrambler of the transmitter to be synchronous to the seed within the descrambler to accurately recover the raw data transmitted by the transmitter as scrambled data.

FIG. 1 shows the structure for a known scrambler 100 that can be used for communications including wireless communications, USB Power delivery, or power line communications. The scrambler 100 shown can be embodied as an integrated circuit (IC) which comprises a linear feedback shift register having a plurality of delay elements, with an eight (8) bit shift register shown. The sync word shown in FIG. 1 as sync_n itself is used to indicate the scrambling sequence being used, which scrambles and randomizes the transmitted data to generate the scrambled data.

However, despite the actions of the scrambler 100, certain input sequences (i.e., data packets) when combined with a given scrambling sequence may still produce several continuous (strings of) zeros or continuous one patterns in the transmitted scrambled data that can throw off the tracking loop of the receiver by injecting a large DC offset in the data pattern. A large DC offset may increase the likelihood of an error when a receiver receives the scrambled data packet.

One known method to address this DC offset problem for USB power delivery is disclosed in the USB power delivery specification USB PD V0.3c (hereafter the “USB PD 0.3). USB PD 0.3 discloses scrambling using four different scrambling patterns each associated with a different scrambler seed (hereafter “The USB 0.3 scrambler solution”). These scrambling patterns are generated by seeds each comprising different synch words (such as each being a 8 bit sync word as shown in FIG. 1), which are in the synch portion of the packet transmitted to the receiver.

Moreover, as noted above, in wireless communications a scrambler such as scrambler 100 shown in FIG. 1 may also be used to reduce the probability of having long strings of zeroes or ones appear in transmitted data. For example, wireless personal area networks (“WPANs”) are used to convey information over relatively short distances. Unlike wireless local area networks (“WLANs”), WPANs need little or no infrastructure, and WPANS allow small, power-efficient, and inexpensive solutions to be implemented for a wide range of devices. Smart Utility Networks (“SUNs”) may operate either over short ranges such as in a mesh network where utility meter information is sent from one utility meter to another, or over longer ranges such as in a star topology where utility meter information is sent to a poletop collection point. The terms WPAN and SUN are used interchangeably herein.

### SUMMARY

Disclosed embodiments are directed, in general, to communications and, more specifically, to methods of communicating scrambling seed information from transmitters to receivers, and transmitters and receivers for executing such methods which may include one or more integrated circuits (IC)-based components. Instead of using the sync word itself to indicate the scrambling sequence used for scrambling the data as described above, a fixed number of bits “M” in the header are instead allocated to indicate the scrambling seed used in the packet transmitted.

In one embodiment, raw data to be transmitted is obtained using a processor, and scrambled data is generating from the raw data according to a scrambling seed. A scrambled data packet structure is configured by combining a preamble portion, a synch portion, and a header portion to the scrambled data, wherein the header portion includes a scrambler field value including a plurality of bits (M). The scrambled data packet structure is then transmitted by the transmitter to the receiver.

### BRIEF DESCRIPTION OF THE DRAWINGS

Having thus described the invention in general terms, reference will now be made to the accompanying drawings, which are not necessarily drawn to scale, and wherein:

FIG. 1 shows the structure of a known scrambler for communications.

FIG. 2 shows the structure of a packet for Universal Serial Bus (USB) for power delivery upon which some example embodiments can be implemented.

FIG. 3 is a flow chart that shows steps in an example method of communicating scrambling seed information, according to an example embodiment.

FIG. 4 shows a pair of USB devices performing USB power delivery communications which implement disclosed communicating of scrambling seed information, where each USB device includes an IC, according to an example embodiment.

FIG. 5 illustrates a pair of wireless devices performing wireless communications over a wireless network which implement disclosed communicating of scrambling seed information, where the wireless devices each include an IC, according to an example embodiment.

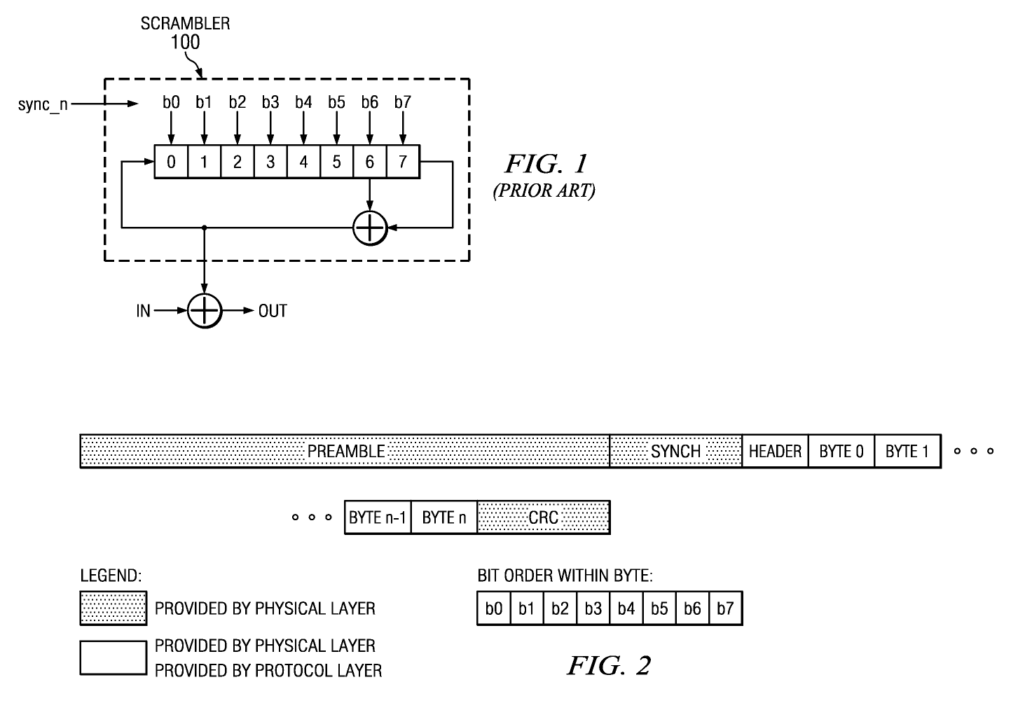

### DETAILED DESCRIPTION

Disclosed embodiments now will be described more fully hereinafter with reference to the accompanying drawings. Such embodiments may, however, be embodied in many different forms and should not be construed as limited to the embodiments set forth herein. Rather, these embodiments are provided so that this disclosure will be thorough and complete, and will fully convey the scope of this disclosure to those having ordinary skill in the art. One having ordinary skill in the art may be able to use the various disclosed embodiments and there equivalents.

Disclosed embodiments recognize known methods for communicating multiple scrambling patterns to the receiver, including by transmitting sync words as described above has several problems. For example, the receiver has to employ four correlators (and additional hardware and/or additional software as a result) for correlating against each of the four different synch words that may be transmitted. This results in an increase in complexity of the receiver. In addition, the number of possible different scrambling patterns that can be used is generally limited to 4 so as not to further increase the receiver complexity.

Disclosed embodiments provide a comparatively simple solution as compared to the USB PD 0.3 scrambler solution for communicating multiple scrambling seeds to the receiver, without a loss in whitening performance. As disclosed above, the reason for using scrambling is to avoid DC patterns in the data portion received that may throw off the receiver tracking algorithm, which can introduce spectral lines in the spectrum. Disclosed embodiments recognize since the header in USB power delivery data packets, such as in USB PD 0.3, and data packets for other communications including wireless communications and power line communications, is relatively short in length, being only 16 bits for USB PD 0.3, a fixed number of additional bits “M” that set a binary scrambler field value can be added to the header to specify the scrambling seed in the packet. Other than the added scrambler field value, disclosed headers are otherwise unchanged, so that they continue to include addressing and other data needed for the packet to reach its intended destination. The disclosed scrambler field value can be added to any portion of the header, such as the beginning or the end of the header.

The mapping of scrambler field values to scrambling seeds may be stored in memory of the receiving device or hard-coded therein. One skilled in the art will appreciate that the scrambling seeds may also be mapped to the scrambler field bits in other ways.

In disclosed packet arrangements, a fixed number of bits “M” in the header are allocated to indicate the scrambling seed used in the packet. Adding M bits to the header results in the total header size for the 16 bit header case to become 16+M bits. In the case four different scrambling seeds as used in the USB PD 0.3 then M=2. Table 1 below shows example 8 bit scrambling seeds for the case of M=2, where the 2 scrambler field bits are within the header of the packet.

TABLE 1

| Scrambler field MSB | Scrambler field LSB | Scrambling seed |
|---|---|---|
| 0 | 0 | 0 0 0 0 1 0 1 1 |
| 1 | 0 | 0 0 0 0 1 1 1 0 |
| 0 | 1 | 1 0 1 1 1 0 1 1 |
| 1 | 1 | 1 0 1 1 1 1 1 0 |

Since the additional complexity of indicating the scrambling seed for the scrambler by adding bits in the header is not significant as it adds minimal overhead and a minimal decoding load, the scrambler field in the header can comprise more than 2 bits to allow more different scrambling code patterns to be used. For example, M=4 allows 16 different scrambling code patterns to be used.

From the receiver perspective the reception algorithm can include receiving the preamble and the synch word of the packet and estimating the frequency offset and timing offset therefrom. The receiver then can turn off the tracking of the frequency offset and timing offset, to prepare for header reception. The header portion including the disclosed scrambler field value is then received. The data portion of the packet is then received, and the data decoded using the scrambling seed determined from the scrambler field code in the header, such as by mapping the scrambler field value (e.g., 01) to its corresponding scrambling seed (e.g., 10111011) stored in the memory of the receiver.

In embodiments where the header and data portions are encoded with a forward error correction (FEC), a single cyclic redundancy check (CRC) can be used for the data and header portions. To further increase the fidelity of the header portion, a CRC of length such as 8 bits may also be used for the header portion as a double check before start of decoding the data.

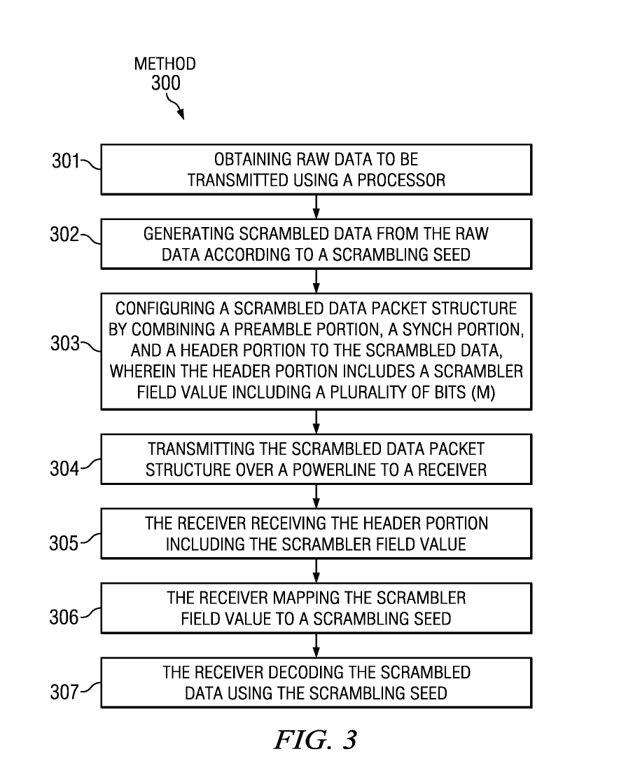

FIG. 3 is a flow chart that shows steps in an example method of communicating scrambling seed information 300, according to an example embodiment. Step 301 comprises obtaining raw data to be transmitted using a processor. The processor can comprise a digital signal processer (DSP), field-programmable gate array (FPGA), application-specific integrated circuit (ASIC), or other suitable processing arrangement. Step 302 comprises generating scrambled data from the raw data according to a scrambling seed.

In step 303 a scrambled data packet structure is configured by combining a preamble portion, a synch portion, and a header portion to the scrambled data, where the header portion includes a scrambler field value including a plurality of bits (M). Step 304 comprises transmitting the scrambled data packet structure to a receiver. The scrambled data packet can be transmitted over a wired medium (e.g., USB cable, or power line), or a wireless medium.

Step 305 comprises the receiver receiving the header portion including the scrambler field value. In step 306 the receiver maps the scrambler field value to a scrambling seed. As disclosed above, the mapping of scrambler field values to the scrambling seed may be enabled by tables stored in the memory of the receiving device or hard-coded therein. Step 307 comprises the receiver decoding the scrambled data using the scrambling seed.

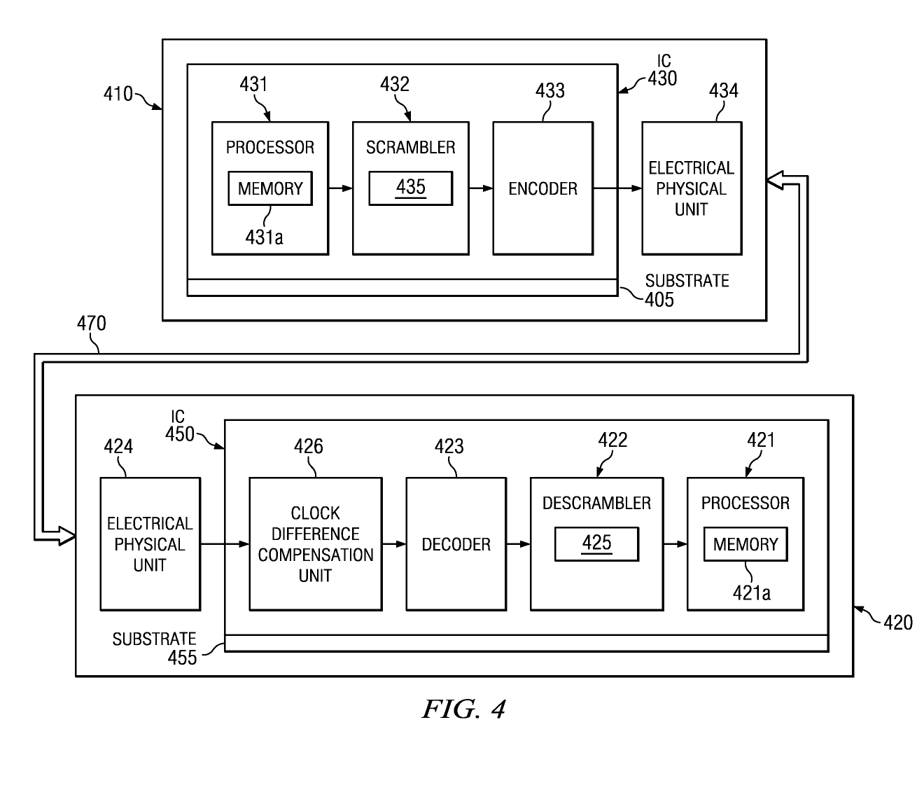

FIG. 4 shows a pair of USB devices 410 and 420 performing USB power delivery or power line communications, according to an example embodiment. As described below, USB device 410 acts as a transmitter by transmitting data via the USB compliant network shown as cable 470 to the USB device 420 which acts as the receiving device.

USB device 410 is shown including an IC 430 and electrical physical unit 434. IC 430 includes a substrate 405 having a semiconductor surface that includes a processor 431, such as a digital signal processor (DSP), a scrambler 432 including a shift register 435, and an encoder 433. However, as described above, processor 431 may be replaced by a FPGA, ASIC, or other suitable arrangement that provides data processing.

Processor 431 includes associated non-transitory machine readable storage shown as memory 431a that stores computer executable instructions which program the scrambler 432 to generate scrambled data from raw data according to a scrambling seed. Shift register 435 can comprise a linear feedback shifter register. The output of the encoder 433 is coupled to the electrical physical unit 434 shown.

The scrambler 432 scrambles the data to be transmitted to generate scrambled data according to the seed provided by the shift register 435. Next, the encoder 433 encodes the scrambled data to generate encoded data and then transmits the encoded data to the electrical physical unit 434. The encoder 433 encodes the scrambled data using a suitable encoding technique. The encoded data can be a symbol, such as with a 10 or 12 bit length. Next, the electrical physical unit 434 transforms the encoded data from parallel to serial form and then transmits the encoded data to the USB device 420 via the cable 470. The electrical physical unit 434 is an input/output interface unit which receives and transmits differential signals that conform to the USB standard.

USB device 420 is shown including an IC 450 and electrical physical unit 424. IC 450 includes a substrate 455 having a semiconductor surface that includes a processor 421, descrambler 422 including register 425, decoder 423 and clock difference compensation unit 426. Processor 421 includes associated non-transitory machine readable storage shown as memory 421a that stores computer executable instructions that program the descrambler 422 to descramble the scrambled data received according to the scrambling seed received from USB device 410. Clock difference compensation unit 426 is coupled to electrical physical unit 424.

When a series of bit data (packet) from USB device 410 is received by USB device 420, the electrical physical unit 424 transforms the received bit data from serial to parallel form to generate a symbol string comprising a plurality of input data, wherein each input data is a symbol with a bit length. Next, the clock difference compensation unit 426 determines whether a compensation procedure is required to be performed or not according to a clock difference between a first clock of the USB device 420 and a second clock of USB device 410, so as to synchronize the transmitted data rate of the USB device 410 and the received data rate of the USB device 420. When the clock difference between the first and second clocks is small, the clock difference compensation unit 426 directly passes the input data to the decoder 423 without performing a compensation procedure. The decoder 423 then decodes the data using a decoding technique to generate data.

The decoded data of USB device 420 is identical to the data of the USB device 410 when the data communication between the USB devices 410 and 420 is correct. Next, the descrambler 422 descrambles the decoded data according to the seed derived by mapping the scrambler field value in the header of the packet received, using the shift register 425 to generate the data and transmit the data to the processor 421 for subsequent applications of the processor 421.

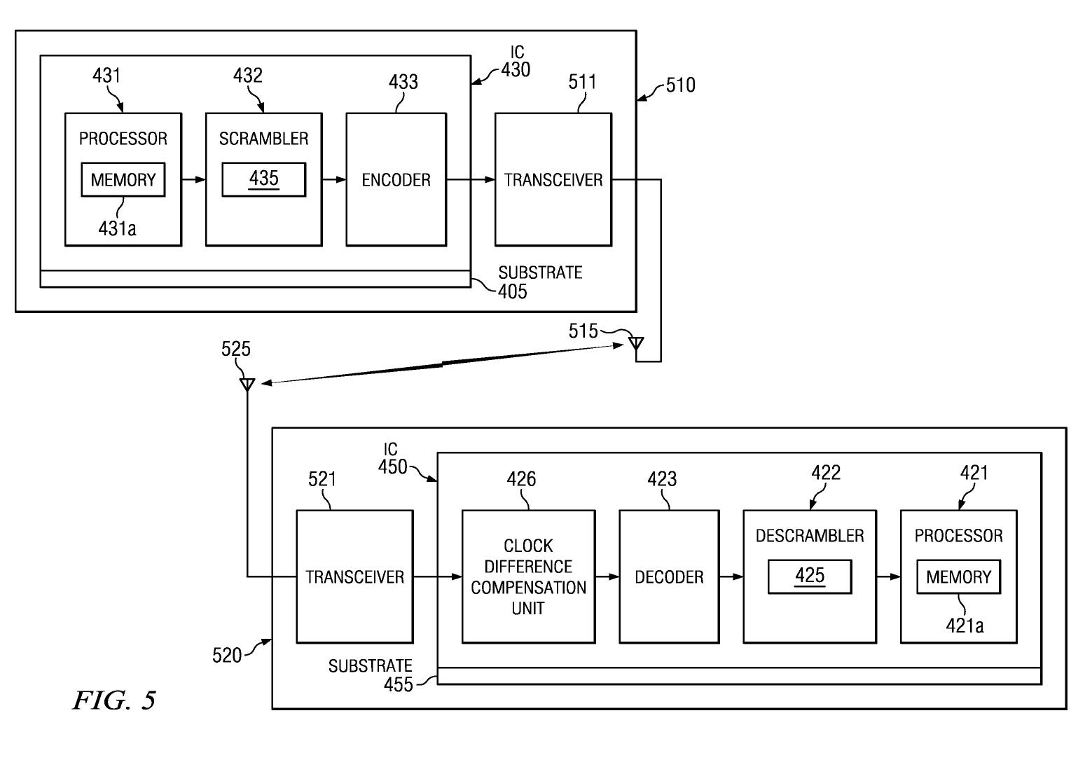

FIG. 5 illustrates a pair of wireless devices 510 and 520 performing wireless communications over a wireless network, according to an example embodiment. Wireless device 510 acts as a transmitter by transmitting data via over the air to wireless device 520 which acts as the receiving device.

Although not shown, wireless devices 510 and 520 can each both include disclosed transmitter circuitry and disclosed algorithms and receiver circuitry and disclosed algorithms. In one embodiment, wireless devices 510 and 520 can communicate over a wireless personal area network (WPAN). Wireless devices 510 and 520 can each comprise a Smartphone, tablet, netbook or laptop computer.

Wireless device 510 includes IC 430 as does USB device 410, and also includes a transceiver 511 that is coupled between the output of the encoder 433 and antenna 515. Wireless device 520 includes IC 450 as does USB device 410, and also includes a transceiver 521 that is coupled between the clock difference compensation unit 426 and antenna 525.

Many modifications and other embodiments of the invention will come to mind to one skilled in the art to which this Disclosure pertains having the benefit of the teachings presented in the foregoing descriptions, and the associated drawings. Therefore, it is to be understood that embodiments of the invention are not to be limited to the specific embodiments disclosed. Although specific terms are employed herein, they are used in a generic and descriptive sense only and not for purposes of limitation.

We claim:

1. A method of communicating scrambling seed information, comprising:
obtaining raw data to be transmitted using a processor;
generating scrambled data from said raw data according to a scrambling seed;
configuring a scrambled data packet structure by combining a preamble portion, a synch portion, and a header portion to said scrambled data, wherein said header portion includes a scrambler field value including a plurality of bits (M), and
transmitting said scrambled data packet structure to a receiver.

2. The method of claim 1, further comprising said receiver:
receiving said header portion including said scrambler field value,
mapping said scrambler field value to a scrambling seed, and
descrambling said scrambled data using said scrambling seed.

3. The method of claim 2, wherein said mapping comprises reading a table stored in a memory of said receiver that relates said scrambler field value to said scrambling seed.

4. The method of claim 2, wherein said header portion and said scrambled data are encoded with a forward error correction (FEC), and wherein a single cyclic redundancy check (CRC) is used by said receiver for said scrambled data and said header portion.

5. The method of claim 2, further comprising said receiver before said decoding:
receiving said preamble portion and said synch portion, and
estimating a frequency offset and timing offset from said preamble portion and said synch portion.

6. The method of claim 1, wherein said communicating comprises Universal Serial Bus (USB) power delivery and connectivity for said USB power delivery communications is provided by a USB compliant network.

7. The method of claim 1, wherein said communicating comprises wireless communications.

8. A transmitter, comprising:
a processor;
a scrambler coupled to said processor, said scrambler comprising a register;
wherein said processor generates raw data to be transmitted with a packet and couples said raw data to said scrambler;
wherein said processor causes said scrambler to generate scrambled data from said raw data according to a scrambling seed;
wherein said processor is programmed to generate a header portion for said packet that includes a scrambler field value including a plurality of bits (M), and
an encoder for encoding said scrambled data to generated encoded scrambled data.

9. The transmitter of claim 8, wherein said processor comprises a digital signal processor (DSP).

10. The transmitter of claim 8, further comprising:
an electrical physical unit for adding a preamble and a synch to said encoded scrambled data and said header for configuring a scrambled data packet structure, and for transmitting said scrambled data packet structure over a wired medium to a receiver.

11. The transmitter of claim 8, wherein said processor adds said preamble and said synch to said encoded scrambled data and said header to configure a scrambled data packet structure, further comprising a transceiver coupled to an antenna for wirelessly transmitting said scrambled data packet structure to a receiver.

12. The transmitter of claim 8, wherein said transmitter comprises:
an integrated circuit (IC) comprising a substrate having a semiconductor surface,
wherein said processor, said scrambler and said encoder are formed in and on said semiconductor surface.

13. A receiver, comprising:
a decoder coupled to receive a scrambled data packet that includes a preamble portion, a synch portion, a header portion and scrambled data portion, wherein said header portion includes a scrambler field value including a plurality of bits (M) which indicate a scrambling seed used;
decoding said scrambled data portion to generate a decoded scrambled data portion;
determining said scrambling seed from said plurality of bits (M), and
descrambling said decoded scrambled data portion,
wherein said descrambler descrambles said decoded scrambled data according to said scrambling seed to generate data.

14. The receiver of claim 13, wherein said receiver includes non-transitory machine readable storage that includes a table that relates said scrambler field value to said scrambling seed.

15. The receiver of claim 13, wherein said processor comprises a digital signal processor (DSP).

16. The receiver of claim 13, further comprising:
an electrical physical unit for transforming received bit data in said scrambled data packet from serial to parallel form to generate a symbol string comprising a plurality of input data, wherein each input data is a symbol with a bit length.

17. The receiver of claim 13, further comprising a transceiver coupled to antenna for wirelessly receiving said scrambled data packet transmitted by a wireless transmitter.

18. The receiver of claim 13, said receiver comprises:
an integrated circuit (IC) comprising a substrate having a semiconductor surface,
wherein said processor, said descrambler and said decoder are formed in and on said semiconductor surface.
